(19) United States
(12) Patent Application Publication
(10) Pub. No.: US 2014/0036364 A1
(43) Pub. Date: Feb. 6, 2014

(54) REGULAR PENTAGON-ARRANGED OPTICAL BEAM SPLITTING AND COMBINING ASSEMBLY

(71) Applicant: Optomak, Inc., Quebec (CA)

(72) Inventor: Sead Doric, L'Ancienne-Lorette (CA)

(73) Assignee: Optomak, Inc., Quebec (CA)

(21) Appl. No.: 13/955,555

(22) Filed: Jul. 31, 2013

Related U.S. Application Data
(60) Provisional application No. 61/678,822, filed on Aug. 2, 2012.

(51) Int. Cl. G02B 27/14; G02B 27/28; G02B 27/10

(52) U.S. Cl. CPC G02B 27/145; G02B 27/1006; G02B 27/283; G02B 27/144
USPC 359/489.08; 359/629; 359/634; 359/638

(57) ABSTRACT

A regular pentagonal arrangement of multiple selectively transmitting interfaces provides a beam-splitter and beam combiner in a compact and cost-effective package. The selectively transmitting interfaces are either provided on transparent plates, or alternatively can be external surfaces of a solid transparent prism. One or more of the sides of the regular pentagonal arrangement includes a transparent or absent surface, so that for beam-splitter operation, the input light can be introduced, and for beam combiner operation, the combined light can be emitted. In beam-splitter operation, the input optical beam is introduced through the transparent side, and is sequentially reflected between the plurality of selectively transmitting interfaces, with beams containing the wavelengths corresponding to each of the selectively transmitting interfaces being emitted from the corresponding surface to the outside of the beam-splitter. Similarly, for beam combiner operation, optical beams of differing wavelengths are introduced through their corresponding sides and emitted from the transparent side.

This U.S. Patent Application claims priority under 35 U.S.C. 119 to U.S. Provisional Patent Application Ser. No. 61/678,822 filed on Aug. 2, 2012.

### BACKGROUND OF THE INVENTION

1. Field of the Invention

The present invention relates to the field of optical devices and systems, and more particularly concerns optical assemblies for splitting and/or combining optical beams.

2. Description of Related Art

Optical beam splitters and combiners are useful devices for respectively splitting and combining optical beams of light having different optical characteristics (e.g. wavelengths, polarization states), which have been implemented into a wide array of optical systems and applications. For example, projectors generally form images by manipulating the relative intensities of three wavelength bands of relatively narrow bandwidth, typically in the red, green and blue regions of the electromagnetic spectrum (i.e. RGB arrangement), using three-channel beam combiners. Likewise, high-quality cameras rely on similar devices in a reverse way, that is, for splitting white light into three RGB spectral components which are subsequently directed to three different image sensors such as charge-coupled devices (CCDs).

In numerous illumination applications, beam combiners are used to combine light of various colors (i.e. wavelength bands) produced from light sources such as light-emitting diodes (LEDs) or lasers into a spectrally broader light output so as to re-create so-called “white light”. The concept of white light is linked with the perception and physiology of the human eye and is based on the premise that red, green and blue lights may be combined in order to make up light containing several wavelength bands inside the visible wavelengths, that is, white light. However, in several instances, the concept of white light may not be sufficient to cover wavelength bands lying outside the visible spectrum commonly used in modern photonics applications. For example, in fields such as life sciences, microscopy, spectroscopy, and laser processing of materials, there is a need for combining or splitting more than three spectral components, often over portions of the electromagnetic spectrum wider or outside the range of visible light or with higher spectral resolution than what is currently achievable in standard RGB applications. In particular, some imaging systems rely on thin-film interference coating technology to separate an optical beam into a plurality of spectrally narrower beams, or to combine the spectral content of a plurality of light beams into a spectrally broader beam. Yet, in the art, the term “white light” is still often understood as being limited to the portion of the electromagnetic spectrum that is visible to the human eye. The above-given interpretation is often restrictive because it does not encompass technologically relevant portions of the spectrum other than visible light.

In the context of the present disclosure, dichroic mirrors capable of separating light into different wavelength bands can be fabricated by depositing specific thin-film coatings on an optical surface substrate. Using such dichroic mirrors, combining light sources in different wavelength bands into a spectrally broader output or separating an input optical beam into a plurality of spectrally narrower light components may be achieved using various configurations of prism, glass plates, and structural mechanical elements. The problem of separating a broad light source into three distinct light beams is well known in the art and several complex and compact solutions have been proposed for the above-described purpose, for example the three-color prism described in U.S. Pat. No. 3,905,684 to Cook et al. and the dichroic pentaprism described in U.S. Pat. No. 5,828,497 to Neumann et al. These two examples illustrate a need to provide compact optical assemblies and to account for performance issues related to the influence of the polarization state and the angle incidence of light impinging on dichroic mirrors. In many optical applications, light is incident on dichroic mirrors or other selectively transmitting elements at an angle of incidence of 45 degrees, which may introduce undesirable polarization-related effects arising from the fact that the polarization state of light is affected at such a large angle of incidence. For example, the transmission and reflection coefficients of the P and S polarization states, the components of light polarized respectively in and out of the plane of incidence defined by the propagation direction of light and the normal to the interface exhibit different wavelength-dependent behaviors, which may be unacceptable in some applications.

Furthermore, existing methods for splitting an input optical beam into three spectral components are generally complex, bulky and costly, and many manufacturers are therefore intentionally avoiding their use. For example, only the most expensive present-day cameras are equipped with three-color beam-splitting prisms. Hence, with the ever increasing number of efficient narrow-wavelength-band LED and laser sources operable from the infrared to the ultraviolet range, optical devices capable of splitting and combining the spectral content of these light sources become highly desirable. In particular, the need for combining more than three wavelength bands of collimated LED or laser sources into a single optical beam is well established, as evidenced by the various products offering four-color mixing LED units launched on the market in recent years. However, these solutions come in relatively large and bulky packages, exhibit limited efficiency, and involve expensive dichroic filters used at 45-degree angles of incidence.

In view of the above, there exists a need in the art for a cost-effective, high-spectral resolution and compact optical assembly capable of splitting/combining polarized and unpolarized optical beams over broad regions of the electromagnetic spectrum, while also alleviating at least some of the drawbacks of the prior art.

### BRIEF SUMMARY OF THE INVENTION

According to an aspect of the invention, there is provided a regular pentagon-arranged optical assembly for splitting an input optical beam into spectrally narrower output optical beams, or for combining input optical beams into a spectrally broader output optical beam. Between two and five can be split or combined in the above-described manner. The optical assembly includes five interfaces arranged with respect to one another so as to define a regular pentagonal arrangement. Some of these interfaces are selectively transmissive, while the others are transparent to the circulating light. The optical assembly according to embodiments of the present invention therefore splits or combines optical beams through multiple successive transmissions and internal reflections of optical beams impinging onto the selectively transmitting interfaces. The number of selectively transmissive interfaces corresponds to the number of optical beams to be split or combined, minus one; for example, in one embodiment, the optical assembly is used for splitting or combining five wavelength bands λ₁, λ₂, λ₃, λ₄ and λ₅, and includes four selectively transmitting interfaces.

Embodiments of the present invention yield compact optical assemblies which may be used to combine or split optical beams for various optical applications and in numerous fields including, without being limited to, optogenetics, wavelength-division multiplexing (WDM), life sciences, microscopy, and LED color mixing.

Advantageously, the angle of incidence of any beam impinging on the selectively transmitting interfaces is preferably equal to 18 degrees and is preserved after each transmission and internal reflection involved in the splitting or the combining process. Also advantageously, such a relatively small angle of incidence contributes to mitigating the polarization sensitivity of the optical assembly according to embodiments of the invention, thereby making it more effective at splitting or combining than existing optical beam splitters and combiners.

In some embodiments, the selectively transmitting interfaces are embodied by coatings deposited on glass plates defining corresponding sides of a hollow regular pentagon. In other embodiments, the selectively transmitting interfaces are coated on corresponding sides of a regular glass pentagonal prism.

In some embodiments, the selectively transmitting interfaces are embodied by dichroic mirrors. Alternatively, in other embodiments, the selectively transmitting interfaces may be embodied by polarization-selective interfaces, wavelength-independent partially reflecting mirrors, or intensity beam splitters. In some of these latter embodiments, the optical assembly may be used as an intensity beam splitter. In further embodiments, the selectively transmitting interfaces may include combinations of dichroic mirrors and intensity filters.

In some embodiments, the optical assembly further includes glass wedges bonded to some of the sides of the regular glass pentagonal prism, so as to ensure that the input and output optical beams respectively enters and exits the optical assembly perpendicularly to an outer surface thereof, thereby advantageously minimizing undesirable polarization-dependent effects.

Other features and advantages of the present invention will be better understood upon reading of preferred embodiments thereof with reference to the appended drawings.

### BRIEF DESCRIPTION OF THE SEVERAL VIEWS OF THE DRAWINGS

FIGS. 1A to 1C are schematic illustrations of an optical assembly for splitting (FIGS. 1A and 1B) and combining (FIG. 1C) five wavelength bands and including four selectively transmitting interfaces defining four sides of a hollow regular pentagon, in accordance with embodiments of the invention. In FIGS. 1A and 1C, each spectral component of the input optical beam is depicted as a separate beam, while in FIG. 1B, the input optical beam is represented as a single beam whose thickness decreases through successive interactions with the selectively transmitting interfaces.

FIGS. 2A and 2B are schematic illustrations of an optical assembly for splitting/combining five wavelength bands and including four selectively transmitting interfaces coated on four sides of a regular glass pentagonal prism, in accordance with an embodiment of the invention. The optical assembly also includes four 18-degree glass wedges bonded to the four selectively transmitting interfaces, and a thick glass biprism with an apex angle of 144 degrees bonded to the remaining side of the regular glass pentagonal prism. In FIG. 2A, each spectral component of the input optical beam is depicted as a separate beam, while in FIG. 2B, the input optical beam is represented as a single beam whose thickness decreases through successive interactions with the selectively transmitting interfaces.

FIG. 3 is a schematic illustration of an optical assembly for splitting/combining four wavelength bands and including three selectively transmitting interfaces defining three sides of a hollow regular pentagon, in accordance with an embodiment of the invention. For illustrative purposes, each spectral component of the input optical beam is depicted as a separate beam.

FIG. 4 is a schematic illustration of an optical assembly for splitting/combining four wavelength bands and including three selectively transmitting interfaces coated on three sides of a regular glass pentagonal prism, in accordance with an embodiment of the invention. The optical assembly also includes 18-degree glass wedges bonded to the five sides of the regular glass pentagonal prism. For illustrative purposes, each spectral component of the input optical beam is depicted as a separate beam.

FIG. 5 is a schematic illustration of an optical assembly for splitting/combining three wavelength bands and including two selectively transmitting interfaces defining two sides of a hollow regular pentagon, in accordance with an embodiment of the invention. For illustrative purposes, each spectral component of the input optical beam is depicted as a separate beam.

FIG. 6 is a schematic illustration of an optical assembly for splitting/combining three wavelength bands and including two selectively transmitting interfaces coated on two sides of a regular glass pentagonal prism, in accordance with an embodiment of the invention. The optical assembly also includes 18-degree glass wedges bonded to the four optically-active sides of the regular glass pentagonal prism. For illustrative purposes, each spectral component of the input optical beam is depicted as a separate beam.

FIG. 7 is a schematic illustration of an optical assembly for splitting/combining two wavelength bands and including one selectively transmitting interface defining one side of a hollow regular pentagon, in accordance with an embodiment of the invention. For illustrative purposes, each spectral component of the input optical beam is depicted as a separate beam.

FIG. 8 is a schematic illustration of an optical assembly for splitting/combining two wavelength bands and including one selectively transmitting interface coated on one side of a regular glass pentagonal prism, in accordance with an embodiment of the invention. The optical assembly also includes 18-degree glass wedges bonded to the three optically-active sides of the regular glass pentagonal prism. For illustrative purposes, each spectral component of the input optical beam is depicted as a separate beam.

FIG. 9 is a schematic illustration of an optical assembly for splitting/combining four wavelength bands and including three selectively transmitting interfaces arranged in a regular pentagonal configuration, in accordance with an embodiment of the invention, wherein the selectively transmitting interfaces are followed by plano-convex lenses perpendicular to exiting beams.

FIG. 10 is a cross-sectional top view of an optical assembly for splitting/combining four wavelength bands and including three selectively transmitting interfaces coated on three sides of a regular glass pentagonal prism, in accordance with an embodiment of the invention. The optical assembly includes 18-degree wedges bonded to the five sides of the regular glass pentagonal prism and plano-convex lenses perpendicular to the beams entering or exiting the assembly. For illustrative purposes, each spectral component of the input optical beam is depicted as a separate beam.

FIG. 11 is a cross-sectional top view of an optical assembly for combining four wavelength bands and including three selectively transmitting interfaces arranged in a regular pentagonal configuration, and four input optical beams to be combined by the optical assembly.

### DETAILED DESCRIPTION OF THE INVENTION

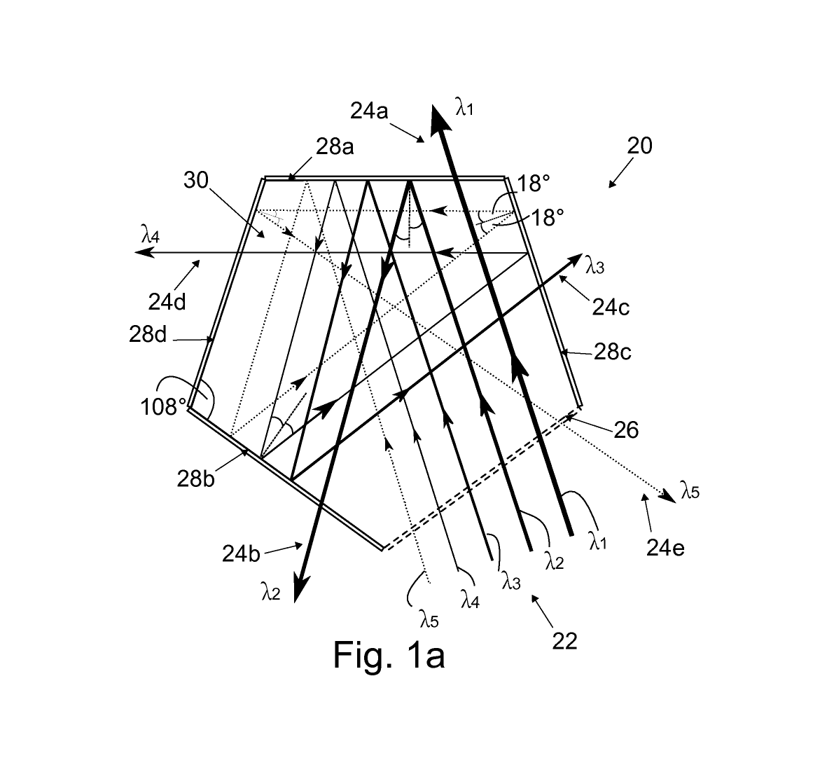

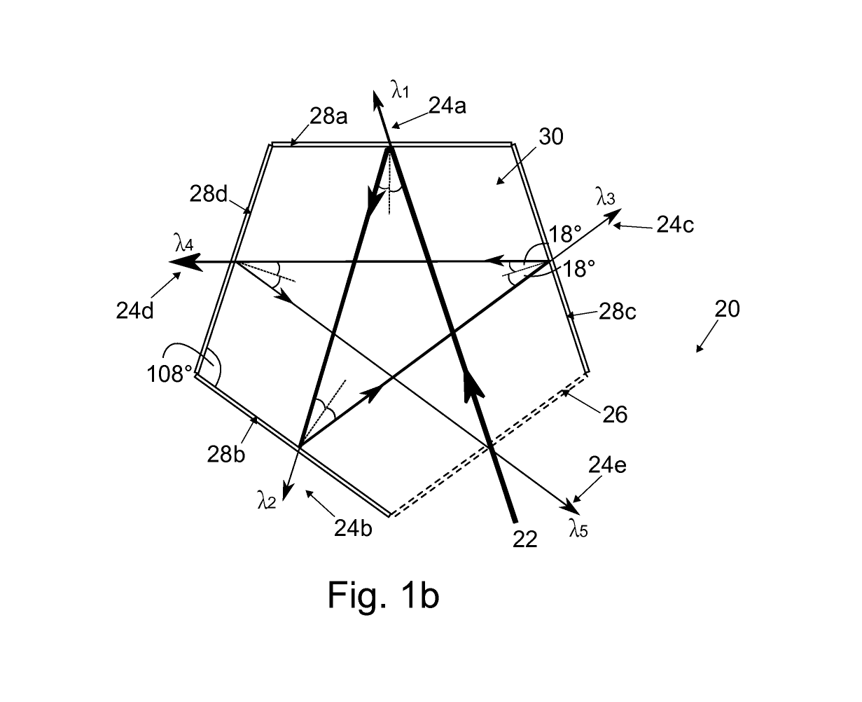

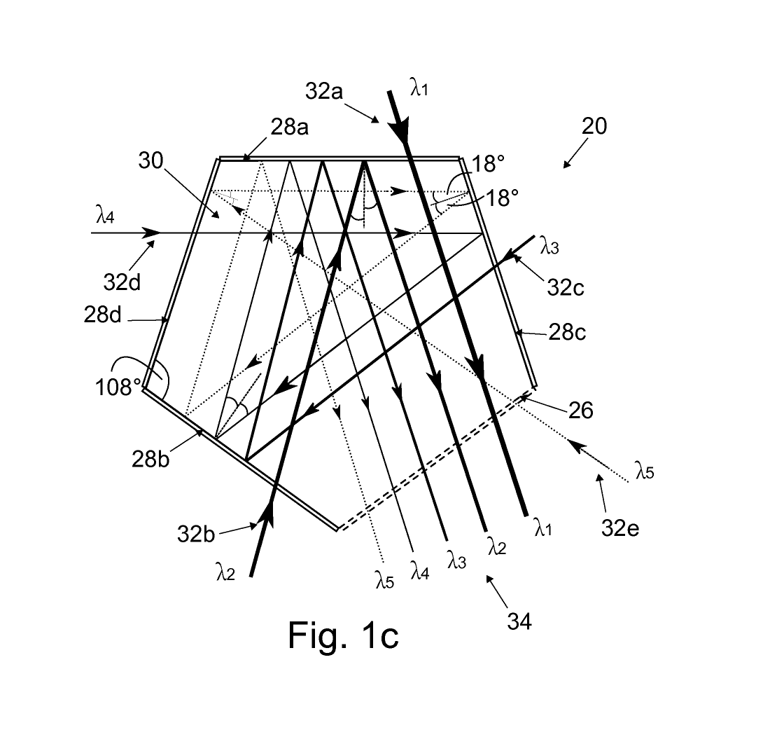

Referring to FIGS. 1A and 1B, there is shown an optical assembly 20 for splitting/combining five wavelength bands, in accordance with an embodiment of the invention. In the illustrated embodiment, the optical assembly 20 is used as a beam splitter for splitting an input optical beam 22 into five spectrally narrower output optical beams 24a to 24e covering different wavelength bands designated as λ₁, λ₂, λ₃, λ₄ and λ₅, respectively, wherein λ₁>λ₂>λ₃>λ₄>λ₅. It will be understood, however, that in other embodiments, such as that described below with reference to FIG. 1C, the optical assembly 20 may be used as a beam combiner.

One of ordinary skill in the art will understand that embodiments of the present invention may be useful to combine or split optical beams in various applications and in numerous fields including, without being limited to, optogenetics, wavelength-division multiplexing (WDM), life sciences, microscopy, and LED color mixing.

As used herein the term “optical beam” is meant to refer to any electromagnetic radiation of appropriate wavelength, preferably in covering a range encompassing the infrared, visible an ultraviolet portions of the electromagnetic spectrum. The optical beam may be produced by a laser source, a collimated LED source, a fiber-optic light source or any other appropriate light-emitting element.

The optical assembly 20 includes a transparent interface 26 and four selectively transmitting interfaces 28a and 28d. As illustrated in FIGS. 1A and 1B, the transparent interface 26 and the four selectively transmitting interfaces 28a to 28d each defines a respective side of a hollow regular pentagon 30, wherein adjacent sides are oriented at an angle of 108 degrees from one another.

In the illustrated embodiment, the transparent interface 26 is simply an open aperture (e.g. air), but those of ordinary skill in the art will recognize that it could alternatively be embodied by a layer of transparent material (e.g. a glass plate) that allows the input optical beam 22 to penetrate inside the hollow regular pentagon 30.

Throughout the present description, the term “selectively transmitting interface” is understood to refer to an interface which selectively transmits electromagnetic radiation according to a given optical parameter thereof. It may include, without being limited to, wavelength-selective interfaces (e.g. dichroic mirrors and filters), polarization-selective interfaces (e.g. polarizers or polarization filters), wavelength-independent partially reflecting mirrors and intensity beam splitters.

In the illustrated embodiment, the four selectively transmitting interfaces 28a to 28d are four dichroic mirrors whose optical properties are relative orientation are selected so as to allow splitting and combining of the five optical beams 24a to 24e covering the different wavelength bands λ₁, λ₂, λ₃, λ₄ and λ₅, respectively, as described hereinbelow. As used herein, the term “dichroic” refers to an optical property of a material or device which allows selective transmission (or reflection) of optical radiation whose wavelength is within a predetermined range, while reflecting (or transmitting) optical radiation whose wavelength lie outside the predetermined range. Accordingly, the terms “dichroic surface”, “dichroic mirror”, “dichroic filter”, “dichroic reflector”, “dichroic coating”, and the like refer to surfaces, mirrors, filters, reflectors, coatings, and the like that exhibit dichroic characteristics. In particular, the dichroic mirrors embodying the selectively transmitting interfaces 28a to 28d may consist of a transparent substrate (e.g. a glass plate) coated with a dielectric multilayer film including alternating layers of high and low refractive index materials.

It is to be noted that while the selectively transmitting interfaces 28a to 28d are embodied by dichroic mirrors with wavelength-dependent reflection and transmission coefficients in the embodiments described below, one of ordinary skill in the art will understand that in other embodiments, the optical assembly 20 may be also used as an intensity beam splitter, wherein the selectively transmitting interfaces 28a to 28d could be embodied by wavelength-independent partially reflecting mirrors or intensity beam splitters, as mentioned above. In such embodiments, the different separated output optical beams would not correspond to different wavelength bands as above but would be fractions of the input optical beam with the same spectral profile. It will be understood that the separated fractions of the input optical beam need not be all of the same intensity and that the intensity beam splitters could each extract a different proportion of the input optical beam. Furthermore, in other embodiments, the selectively transmitting interfaces 28a to 28d may include a combination of dichroic mirrors and intensity filters.

The optical assembly 20 may also include an appropriate support structure (not shown) for supporting the four selectively transmitting interfaces 28a to 28d deposited on their respective substrate (e.g. glass plate) and them as four sides of the hollow regular pentagon 30. It will be understood by one of ordinary skill in the art that the support structure is preferably lightweight, mechanically strong, and compact, while not obstructing the passage of light as it enters and exits the optical assembly 20. The support structure may be embodied, for example, by a metal housing having a regular pentagonal-shaped hole bored therethrough, thus defining the hollow regular pentagon 30. The metal housing could also be provided with additional holes along the five lateral faces thereof. In such an embodiment, the selectively transmitting interfaces 28a to 28d could be glued or otherwise affixed to the internal side of four of the five lateral faces of the metal housing, such that at least a portion of each of the selectively transmitting interfaces 28a to 28d is disposed in front of the holes, thereby allowing light to enter and exit the optical assembly 20.

Still referring to FIGS. 1A and 1B, it is shown that in use the input optical beam 22 is directed to impinge on the transparent interface 26 at an angle of incidence of 18 degrees. As known in the art, the term “angle of incidence” refers to the angle formed between an optical beam striking a surface and the normal to that surface at the point of incidence. The transparent interface 26 thus serves as the beam entry port of the optical assembly 20. It is to be noted that, for illustrative purposes, each spectral component λ₁, λ₂, λ₃, λ₄ and λ₅ forming the input optical beam 22 is depicted as a separate beam, while in FIG. 1B, the input optical beam 22 is represented as a single beam whose thickness decreases through successive interactions with the selectively transmitting interfaces 28a to 28d.

After passing through the transparent interface 26, the input optical beam 22 is incident on the first selectively transparent interface 28a, preferably at an angle of incidence of 18 degrees. The first selectively transmitting interface 28a is a dichroic mirror which may be selected so that the longest wavelength band λ₁ is transmitted therethrough out of the optical assembly 20 as the first output optical beam 24a, while the shorter wavelength bands λ₂, λ₃, λ₄ and λ₅ are internally reflected toward the second selectively transmitting interface 28b. It will be understood by one of ordinary skill in the art that, in other embodiments, the first selectively transmitting interface 28a may be designed so as to transmit any one of the five wavelength bands λ₁, λ₂, λ₃, λ₄ and λ₅ without departing from the scope of the present invention.

The second selectively transmitting interface 28b is adapted to receive the input optical beam 22 with remaining wavelength bands λ₂, λ₃, λ₄ and λ₅ at the same 18-degree angle of incidence. In the illustrated embodiment, the dichroic mirror of the second selectively transmitting interface 28b is selected so that the longest remaining wavelength band λ₂ is transmitted therethrough out of the optical assembly 20 as the second output optical beam 24b, while the shorter remaining wavelength bands λ₃, λ₄ and λ₅ are internally reflected toward the third selectively transmitting interface 28c.

The input optical beam 22 with remaining wavelength bands λ₃, λ₄ and λ₅ is subsequently incident on the third selectively transmitting interface 28c of the optical assembly 20, again at an angle of incidence of 18 degrees. The dichroic mirror defining the third selectively transmitting interface 28c transmits therethrough the longest remaining wavelength band λ₃, which exits the optical assembly 20 as the third output optical beam 24c, while the shorter remaining wavelength bands λ₄ and λ₅ are internally reflected toward the fourth selectively transmitting interface 28d.

Finally, the fourth selectively transmitting interface 28d receives thereonto the input optical beam 22 with remaining wavelength bands λ₄ and λ₅. The dichroic mirror embodying the fourth selectively transmitting interface 28d transmits the wavelength band λ₄ out of the optical assembly 20 as the fourth output optical beam 24d and internally reflects the last wavelength band λ₅ toward the transparent interface 26, where it exits the optical assembly as the fifth output optical beam 24e. The exit of optical beam 24e completes the splitting of the input optical beam 22 into output optical beams 24a to 24e. It will be understood that the fully transmitting side of the hollow regular pentagon 30 defined by the transparent interface 26 is crossed by both the input optical beam 22 and the fifth output optical beam 24e, at an angle of 36 degrees from each other.

In summary, the embodiment of FIGS. 1A and 1B allows splitting of the input optical beam 22 entering the optical assembly 20 into five spectrally narrower output optical beams 24a to 24e covering wavelength bands λ₁, λ₂, λ₃, λ₄ and λ₅, respectively, through successive partial transmissions and internal reflections at four selectively transmitting interfaces 28a to 28d. Each wavelength band exits the optical assembly 20 at a different position and in a different direction, thereby facilitating their individual handling. Advantageously, the angle of incidence of any beam impinging on the transparent interface 26 and the selectively transmitting interfaces 28a to 28d is always equal to 18 degrees and is therefore preserved after each transmission and internal reflection involved in the splitting process. It will be further be understood by one of ordinary skill in the art that such a relatively small angle of incidence contributes to mitigating the sensitivity to the polarization of the optical assembly 20 according to embodiments of the invention, thereby making it more effective at splitting or combining randomly polarized (i.e. unpolarized) input light than existing optical beam splitters/combiners. The small angle of incidence also makes the design and production of suitable selectively transmitting interfaces such as dichroic mirrors and partial reflectors possible and less demanding.

It should be noted that, while the splitting of the input optical beam 22 into five spectrally narrower output optical beams 24a to 24e has been described above as being performed in decreasing order of wavelength, that is, from λ₁ to λ₅, in other embodiments the wavelength bands λ₁, λ₂, λ₃, λ₄ and λ₅ may be removed from the input optical beam 22 according to any appropriate order or sequence without departing from the scope of the present invention.

From the above considerations, it will also be apparent to one of ordinary skill in the art that the optical assembly 20 illustrated in FIGS. 1A and 1B may alternatively be used as an optical beam combiner for combining five input optical beams 32a to 32e covering five wavelength bands λ₁, λ₂, λ₃, λ₄ and λ₅, respectively, into a single spectrally broader output optical beam 34, as illustrated in FIG. 1C. In the depicted embodiment, the optical assembly 20 includes the same optical components as in FIGS. 1A and 1B, that is, one transparent interface 26 and four selectively transmitting interfaces 28a to 28d, which collectively defines the five sides of a hollow regular pentagon 30.

As illustrated in FIG. 1C, each of the five input optical beams 32a to 32e is incident on a corresponding side of the hollow regular pentagon 30 at an angle of incidence of 18 degrees. Since the selectively transmitting interfaces 28a to 28d are respectively selected to allow the wavelength bands λ₁ to λ₄ to be transmitted therethrough but to internally reflect the other wavelength bands, the five input optical beams 32a to 32e entering optical assembly 20 all exit the same through the transparent interface 26 so as to form the spectrally broader output optical beam 34.

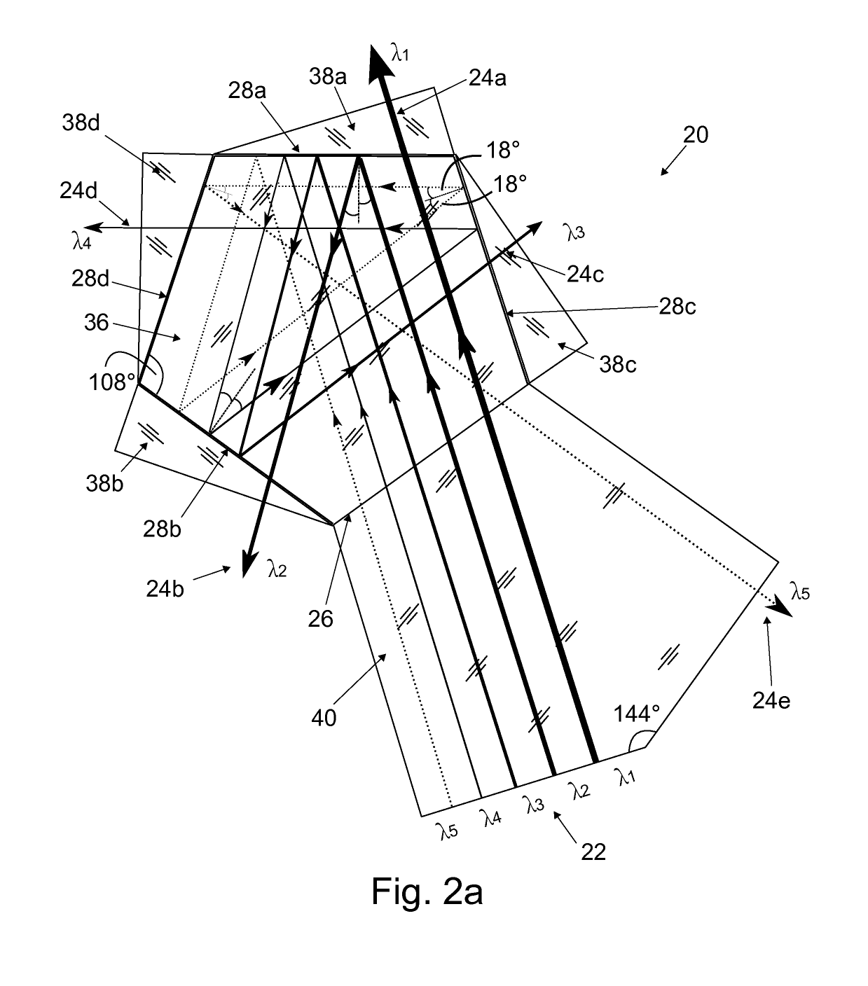

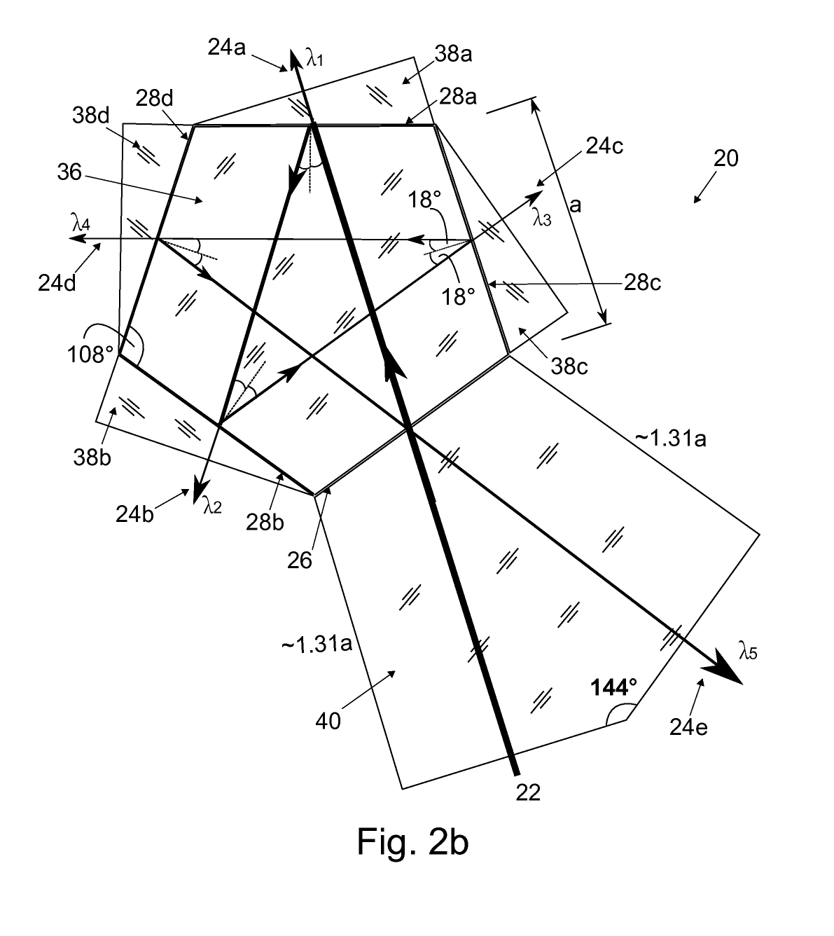

Referring now to FIGS. 2A and 2B, there is shown an alternate embodiment of an optical assembly 20, which is based on the same principle as described above for splitting the input optical beam 22 into five spectrally narrower output optical beam 24a to 24e using a regular pentagonal configuration of four selectively transmitting interfaces 28a to 28d. In the depicted embodiment, the hollow rectangular pentagon 30 of FIGS. 1A and 1B is embodied by a piece of glass shaped in the form of a regular glass pentagonal prism 36 having five rectangular lateral sides and regular pentagonal top and bottom surfaces. Four of the lateral sides have a dichroic surface coated thereon for defining the four selectively transmitting interfaces 28a to 28d of the optical assembly 20. The remaining lateral side of the regular glass pentagonal prism 36 may remain uncoated and defines the transparent interface 26 described above. It will be understood that the glass material making up the regular glass pentagonal prism 36 is preferably transparent to all the optical beams involved in the splitting or combining process.

Furthermore, in the illustrated embodiment, 18-degree glass wedges 38a to 38d are preferably bonded (e.g. glued together using epoxy) or otherwise affixed to the selectively transmitting interfaces 28a to 28d. Likewise, a glass biprism 40 with an apex angle of 144 degrees may be bonded or otherwise affixed to the transparent interface 26 defining the remaining side of the regular glass pentagonal prism 36. It will be understood by one of ordinary skill in the art that the 18-degree glass wedges 38a to 38d and the 144-degree glass biprism 40 allow the input optical beam 22 to enter and the spectrally narrower output optical beams 24a to 24e to exit the optical assembly 20 perpendicularly to an outer surface thereof, thereby advantageously minimizing undesirable polarization-dependent effects on the beams 22 and 24a to 24e. It will be understood that the glass wedges 38a to 38d and the glass biprism 40 are preferably made of the same material as the regular glass pentagonal prism 36. However, in embodiments where the material is not the same, one of ordinary skill in the art will understand that the respective angle defining the glass wedges 38a to 38d and the glass biprism 40 would have to be recalculated to account for the difference in refractive index between the regular glass pentagonal prism 36 and each of the glass wedges 38a to 38d and the glass biprism 40.

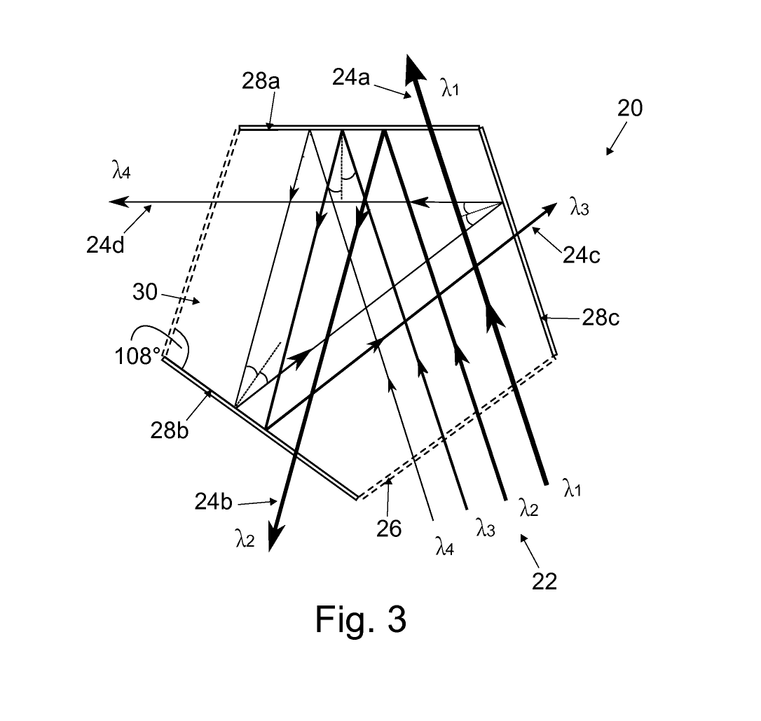

Referring now to FIGS. 3 to 8, there are shown optical assemblies 20 for splitting/combining optical beams according to other embodiments of the invention. Each of these embodiments includes one or more selectively transmitting interfaces arranged according to a regular pentagonal configuration, but allows for the splitting of an input optical beam into less than five spectrally narrower output optical beams or for the combining of less than five input optical beams into a spectrally broader output optical beam.

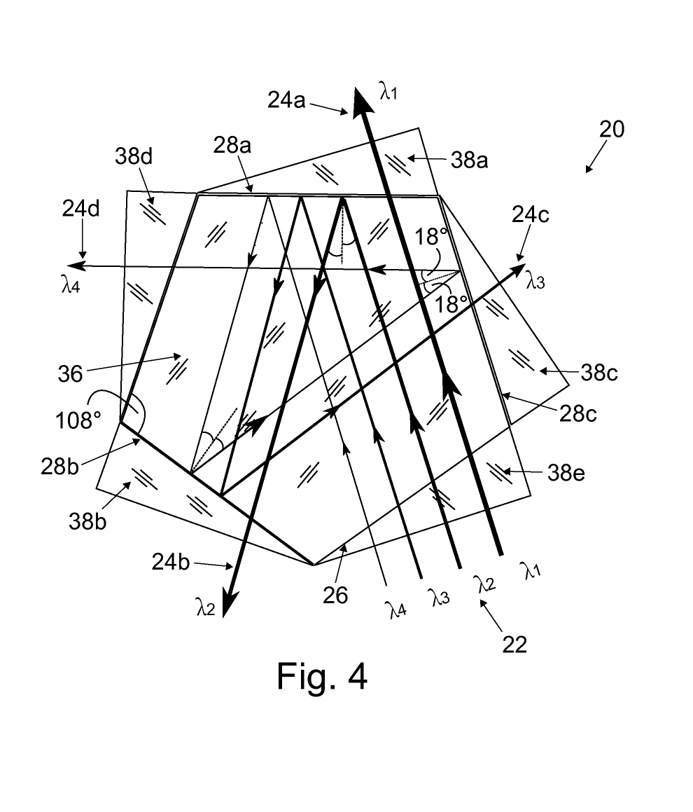

Referring to FIGS. 3 and 4, there are shown two embodiments of an optical assembly 20 for splitting/combining four wavelength bands. In the illustrated embodiments, the optical assembly 20 is used as a beam splitter for splitting an input optical beam 22 into four spectrally narrower output optical beams 24a to 24d covering different wavelength bands λ₁, λ₂, λ₃ and λ₄. Each embodiment includes a transparent interface 26 and three selectively transmitting interfaces 28a to 28c that transmit the wavelength bands λ₁, λ₂, and λ₃, respectively, and internally reflect the other wavelength bands. It will be understood that the fifth side of the optical assembly 20, through which the fourth output optical beam 24d covering the wavelength band λ₄ exits, need not be a selectively transmitting interface like the three selectively transmitting interfaces 28a to 28c since the fifth side is struck by only one optical beam during the splitting or combining process. Indeed, the fourth optically-active side of the optical assembly 20 only needs to be transparent to the fourth output optical beam 24d. In some variants, the fourth optically-active side could for example be coated with an appropriate dichroic mirror but could also be embodied by an open aperture.

In FIG. 3, the selectively transmitting interfaces 28a to 28c are embodied by glass plates coated with a dichroic material and define three sides of a hollow regular pentagon 30, as in FIGS. 1A to 1C. On the other hand, in FIG. 4, the selectively transmitting interfaces 28a to 28c are embodied by a dichroic coating deposited on three sides of a regular glass pentagonal prism 36, as in FIGS. 2A and 2B. The optical assembly 20 of FIG. 4 also includes 18-degree glass wedges 38a to 38e bonded to the five sides of the regular glass pentagonal prism 36. As mentioned above, the glass wedges ensure that the input optical beam 22 enters, and that the spectrally narrower output optical beams 24a to 24e exit the optical assembly 20 perpendicularly to an outer surface thereof, thereby mitigating undesirable polarization-dependent effects.

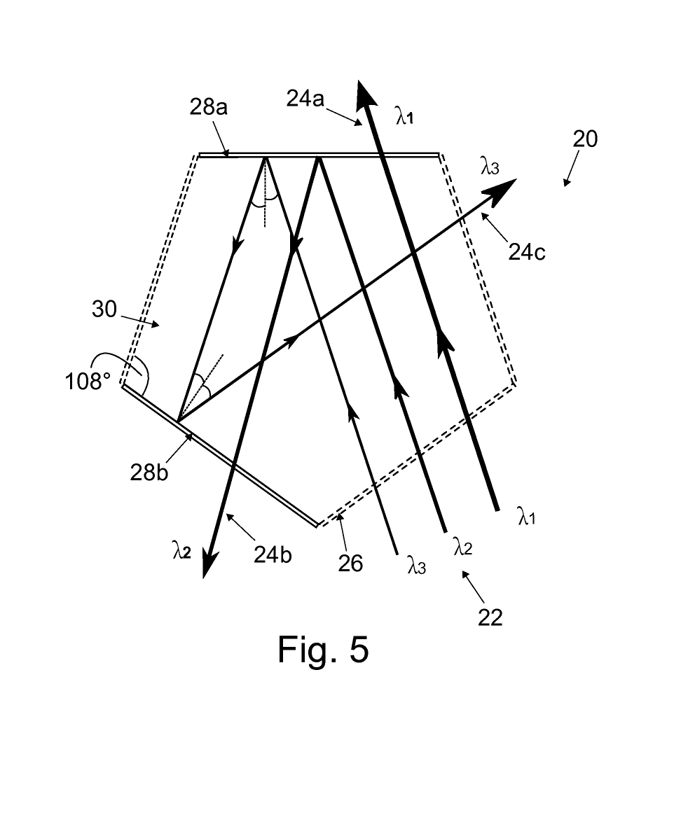

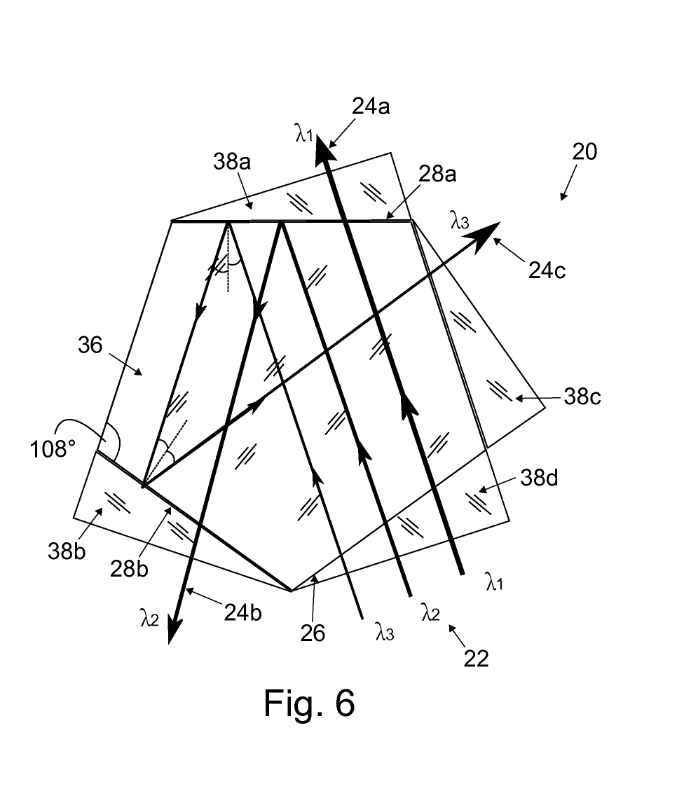

Referring now to FIGS. 5 and 6, there are shown two other embodiments of an optical assembly 20 for splitting/combining three wavelength bands. In the illustrated embodiments, the optical assembly 20 is as used a beam splitter for splitting an input optical beam 22 into three spectrally narrower output optical beams 24a to 24c covering different wavelength bands λ₁, λ₂, and λ₃. Each embodiment includes an transparent interface 26 and two selectively transmitting interfaces 28a and 28b that transmit the wavelength bands λ₁ and λ₂, respectively, and internally reflect the other wavelength bands. As for the embodiments of FIGS. 3 and 4, it will be understood that the fourth optically-active side of the optical assembly 20, through which the third output optical beam 24c covering the wavelength band λ₃ exits, need not be a selectively transmitting interface like the three selectively transmitting interfaces 28a and 28b since the fourth optically-active side is struck by only one optical beam during the splitting or combining process. Indeed, the fourth optically-active side only needs to be transparent to the third output optical beam 24c. Likewise, it will also be understood that no requirement is imposed with regard to the transparency of the non-optically-active side of the optical assembly 20, that is, the side on which no optical beam impinges during the splitting or combining process.

In FIG. 5, the selectively transmitting interfaces 28a and 28b are embodied by glass plates coated with a dichroic material and define two sides of a hollow regular pentagon 30. On the other hand, in FIG. 6, the selectively transmitting interfaces 28a and 28b are embodied by a dichroic coating deposited on two sides of a regular glass pentagonal prism 36. The optical assembly 20 of FIG. 6 also includes 18-degree glass wedges 38a to 38d bonded to the four optically-active sides of the regular glass pentagonal prism 36.

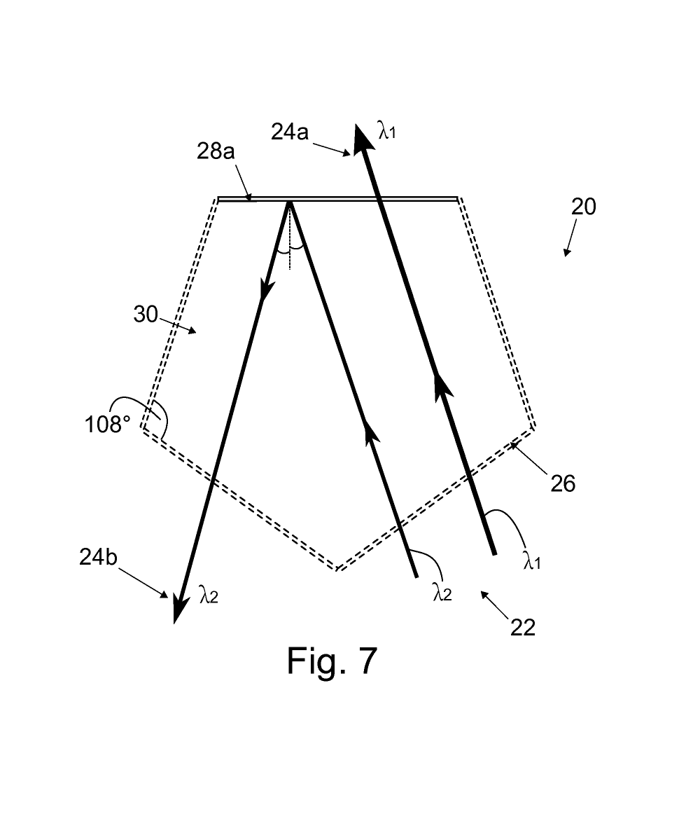

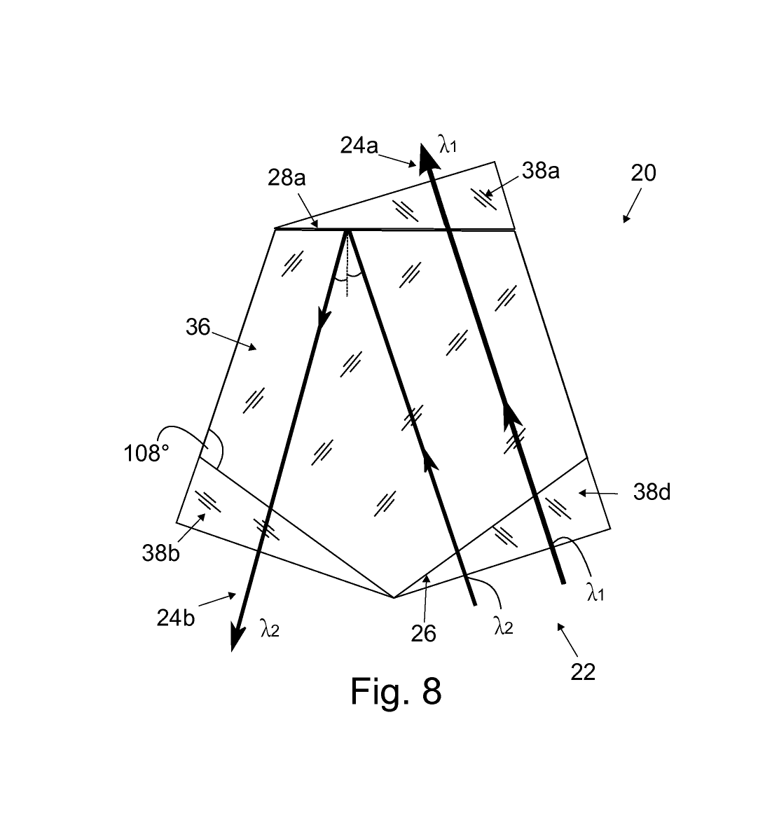

Referring now to FIGS. 7 and 8, there are shown two further embodiments of an optical assembly 20 for splitting/combining two wavelength bands. In the illustrated embodiments, the optical assembly 20 is as used a beam splitter for splitting an input optical beam 22 into two spectrally narrower output optical beams 24a and 24b covering different wavelength bands λ₁ and λ₂. Each embodiment includes a transparent interface 26 and one selectively transmitting interface 28a that transmits the wavelength band λ₁ and internally reflects the wavelength band λ₂. However, the third optically-active side of the optical assembly 20, through which the second output optical beam 24d covering the wavelength band λ₂ exits, need not be a selectively transmitting interface like the selectively transmitting interface 28a since the third optically-active side is struck by only one optical beam during the splitting or combining process. Indeed, the third optically-active side only needs to be transparent to the second output optical beam 24b. Furthermore, it will also be understood that no requirement is imposed with regard to the transparency of the two non-optically-active sides of the optical assembly 20, that is, the sides on which no optical beam impinges during the splitting or combining process.

In FIG. 7, the selectively transmitting interface 28a is embodied by a glass plate coated with a dichroic material and defines one side of a hollow regular pentagon 30. On the other hand, in FIG. 8, the selectively transmitting interface 28a is embodied by a dichroic coating deposited on one side of a regular glass pentagonal prism 36. The optical assembly 20 of FIG. 6 also includes 18-degree glass wedges 38a to 38c bonded to the three optically-active sides of the regular glass pentagonal prism 36.

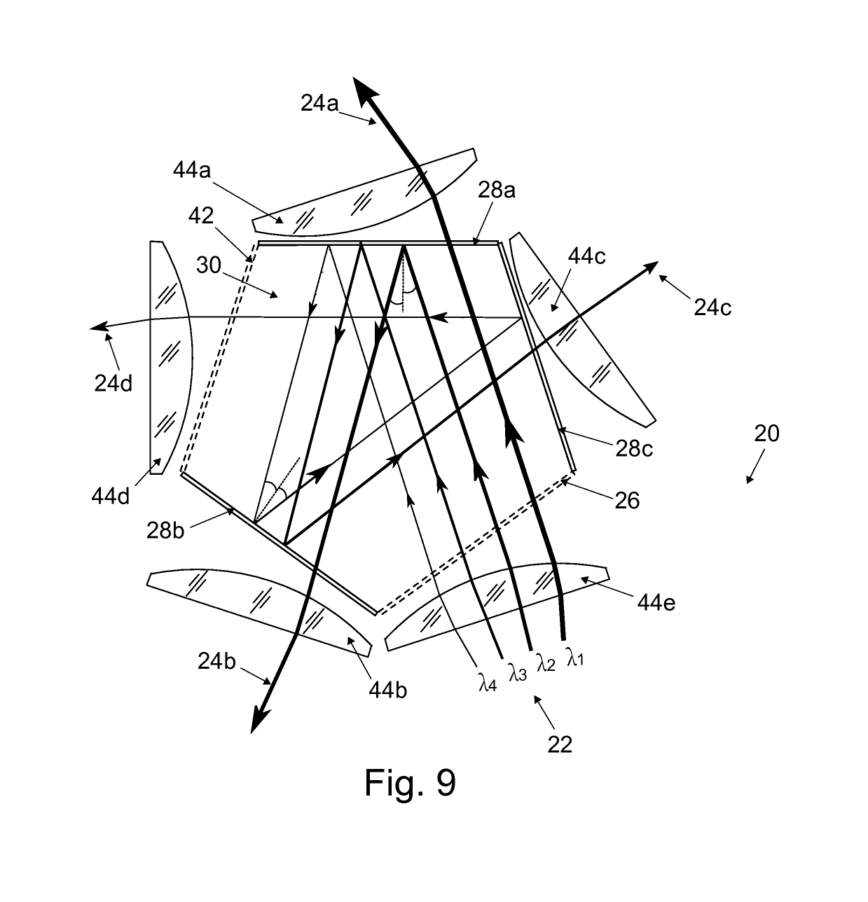

With reference to FIG. 9, there is shown an alternate embodiment of an optical assembly 20 for splitting/combining four wavelength bands λ₁, λ₂, λ₃ and λ₄, and including three selectively transmitting interfaces 28a to 28c embodied by glass plates coated with a dichroic material and defining three sides of a hollow regular pentagon. In the depicted embodiment, the selectively transmitting interfaces 28a to 28c through which are respectively transmitted the output optical beams 24a to 24c and the interface 42 through which is transmitted the output optical beams 24d are followed with of plano-convex lenses 44a to 44d perpendicular to exiting beams. The plano-convex lenses 44a to 44d allow focusing the output optical beams 24a to 24d into other optical components, for example optical fibers or light detectors. Conversely, when the optical assembly 20 is used as a beam combiner, light sources such as LED or laser sources may be provided at or near the respective focal point of the plano-convex lenses 44a to 44d. The plano-convex lenses 44a to 44d are preferably made of a transparent glass material. In some embodiments, the light source (e.g. LED or laser source) may be disposed at or near the focal point of the plano-convex lens 46.

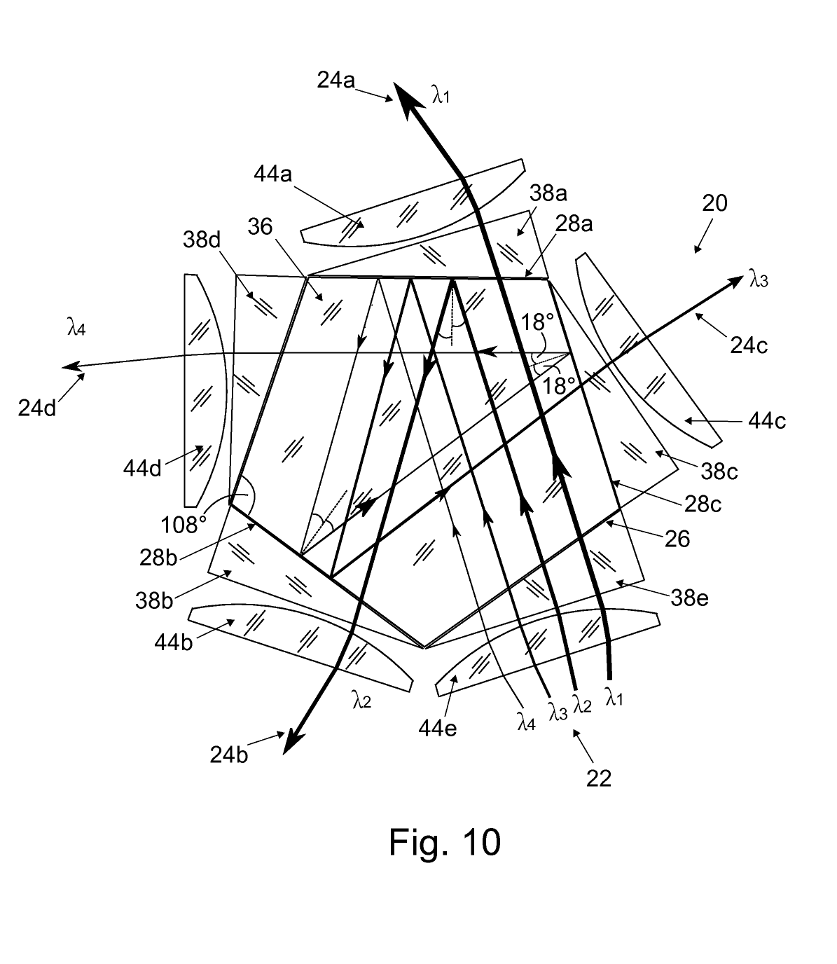

Referring now to FIG. 10, there is shown yet another embodiment an optical assembly 20 for splitting/combining four wavelength bands λ₁, λ₂, λ₃ and λ₄, and including three selectively transmitting interfaces 28a to 28c embodied by a dichroic coating deposited on three sides of a regular glass pentagonal prism 36. In the depicted embodiment, optical assembly 20 also includes 18-degree glass wedges 38a to 38e bonded to the five optically-active sides of the regular glass pentagonal prism 36, and followed by beam focusing lenses 44a to 44e, which are plano-convex that focus the output optical beams 24a to 24d into other optical components, for example optical fibers or light detectors. Conversely, when optical assembly 20 is used as a beam combiner, light sources such as LED or laser sources may be provided at or near the respective focal point of the plano-convex lenses 44a to 44d.

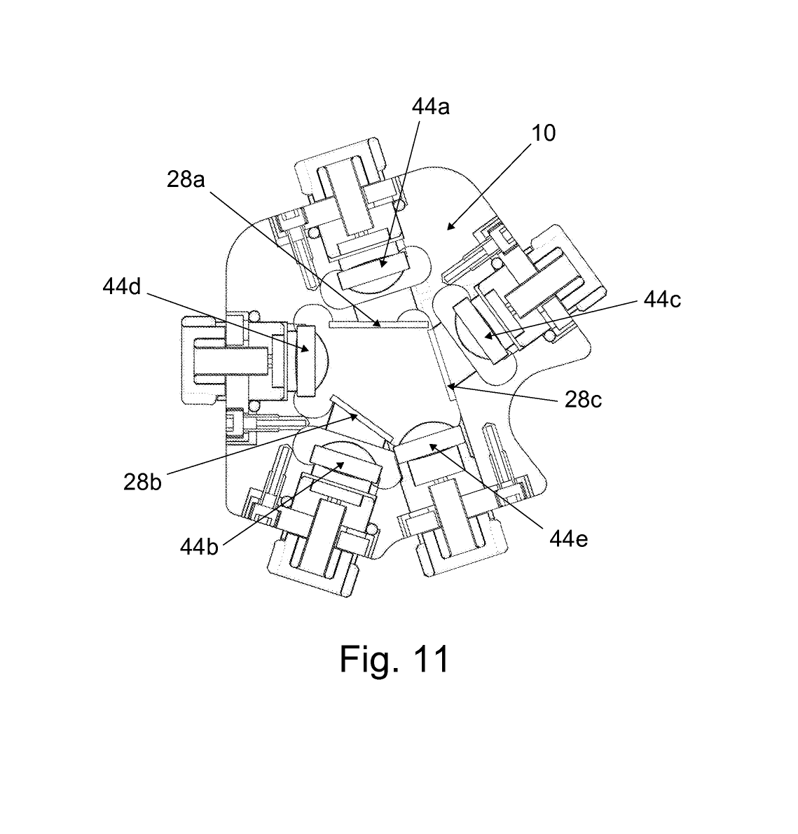

Finally, FIG. 11 is a top view of still another embodiment of a regular pentagon-arranged optical assembly 10 for combining four wavelength bands from four input optical beams. In the illustrated embodiment, the four input optical beams of four sides of the optical assembly 10 and are focused by convex lenses prior to entering the optical assembly 10. Optical assembly includes selectively transmitting interfaces 28a-28c, formed as coatings on optically-transparent plates and arranged in the regular pentagonal arrangement as described above.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. An optical device, comprising:
a plurality of selectively transmitting interfaces for selectively transmitting light and reflecting a remainder of the light; and
a device body for securing the plurality of selectively transmitting interfaces as sides of a regular pentagonal arrangement, wherein portions of one or more optical beams are reflected by the selectively transmitting interfaces to retain the optical beams within the sides of the regular pentagonal arrangement until the one or more optical beams have been transmitted through the plurality of selectively transmitting interfaces or have arrived at a fully-transmissive side of the regular pentagonal arrangement.

2. The optical device of claim 1, wherein the plurality of selectively transmitting interfaces consists of five selectively transmitting interfaces, and wherein the regular pentagonal arrangement does not include a fully-transmissive side.

3. The optical device of claim 1, wherein the optical device is a beamsplitter, and wherein other portions of the one or more optical beams are emitted at corresponding ones of the selectively transmitting interfaces.

4. The optical device of claim 1, wherein the optical device is a beam combiner, wherein the transmissive surface is an exit aperture through which an optical beam exits, and wherein other portions of the optical beam are provided from outside of the regular pentagonal arrangement through corresponding ones of the selectively transmitting interfaces.

5. The optical device of claim 1, wherein the plurality of selectively transmitting interfaces is less than five selectively transmitting interfaces, and wherein one of the sides of the regular pentagonal arrangement is the fully-transmissive side.

6. The optical device of claim 1, wherein the plurality of selectively transmitting interfaces is less than four selectively transmitting interfaces, and wherein multiple one of the sides of the regular pentagonal arrangement are fully-transmissive sides.

7. The optical device of claim 1, wherein the device body is a solid transparent body having sides providing the sides of the regular pentagonal arrangement, and wherein the plurality of selectively transmitting interfaces are provided by coatings on the sides of the device body.

8. The optical device of claim 5, further comprising a plurality of prisms having a triangular cross-section in a plane of the regular pentagonal arrangement, wherein the plurality of prisms are secured and optically-coupled to corresponding sides of the solid transparent body.

9. The optical device of claim 6, further comprising a plurality of lenses disposed at corresponding sides of the regular pentagonal arrangement for focusing the optical beams.

10. The optical device of claim 1, wherein the device body comprises:
a plurality of optically transmissive plates, wherein the plurality of selectively transmitting interfaces are provided by coatings on corresponding ones of the plates; and
a frame for securing the plates in the regular pentagonal arrangement.

11. The optical device of claim 1, further comprising a plurality of lenses disposed at corresponding sides of the regular pentagonal arrangement for focusing the optical beams.

12. The optical device of claim 11, wherein the plurality of lenses are plano-convex lenses.

13. The optical device of claim 1, wherein the plurality of selectively transmitting interfaces are wavelength-selective interfaces, wherein portion of the optical beams having wavelengths other than wavelengths corresponding to the wavelength-selective interfaces are reflected by the selectively transmitting interfaces to retain the optical beams within the sides of the regular pentagonal arrangement until the portions of the optical beams have arrived at ones of the plurality of selectively transmitting interfaces for which the corresponding wavelengths match the wavelengths of the portions of the optical beams or have arrived at the fully-transmissive side of the regular pentagonal arrangement.

14. The optical device of claim 1, wherein the plurality of selectively transmitting interfaces are polarization-selective interfaces.

15. The optical device of claim 1, wherein the plurality of selectively transmitting interfaces are wavelength-independent partially-transmissive mirrors.

16. A method of transforming between a single optical beam and multiple optical beams, the method comprising:
securing a plurality of selectively transmitting interfaces as sides of a regular pentagonal arrangement;
reflecting the multiple beams between the plurality of selectively transmitting interfaces, wherein portions of multiple optical beams are reflected by the selectively transmitting interfaces to retain the multiple optical beams within the sides of the regular pentagonal arrangement until the multiple optical beams have been transmitted through the plurality of selectively transmitting interfaces or have arrived at a fully-transmissive side of the regular pentagonal arrangement.

17. The method of claim 16, wherein the securing secures five selectively transmitting interfaces, and wherein the regular pentagonal arrangement does not include a fully-transmissive side.

18. The method of claim 16, wherein the reflecting splits the single optical beam into the multiple optical beams, wherein the multiple optical beams are emitted at corresponding ones of the selectively transmitting interfaces.

19. The method of claim 16, wherein the reflecting combines the multiple optical beams, wherein the transmissive side is an exit aperture through which the single optical beam exits, and wherein the multiple optical beams are provided from outside of the regular pentagonal arrangement through corresponding ones of the selectively transmitting interfaces.

20. The method of claim 16, wherein the securing secures less than five selectively transmitting interfaces, and wherein one of the sides of the regular pentagonal arrangement is the fully-transmissive side.

21. The method of claim 16, wherein the securing secures less than four selectively transmitting interfaces, and wherein multiple one of the sides of the regular pentagonal arrangement are fully-transmissive sides.

22. The method of claim 16, wherein the securing secures the multiple selectively transmitting interfaces by providing the multiple selectively transmitting interface as coatings on the sides of a solid transparent body having sides providing the sides of the regular pentagonal arrangement.

23. The method of claim 22, further comprising securing a plurality of prisms having a triangular cross-section in a plane of the regular pentagonal arrangement to corresponding sides of the solid transparent body.

24. The method of claim 23, further comprising disposing a plurality of lenses at corresponding sides of the regular pentagonal arrangement for focusing the multiple optical beams.

25. The method of claim 16, wherein the securing secures a plurality of optically transmissive plates in a frame such that the plates are secured in the regular pentagonal arrangement, wherein the plurality of selectively transmitting interfaces are provided by coatings on corresponding ones of the plates.

26. The method of claim 16, further comprising securing a plurality of lenses at corresponding sides of the regular pentagonal arrangement for focusing the optical beams.

27. The method of claim 26, wherein the plurality of lenses are plano-convex lenses.

28. The method of claim 16, wherein the plurality of selectively transmitting interfaces are wavelength-selective interfaces, wherein the optical beams having wavelengths other than wavelengths corresponding to the wavelength-selective interfaces are reflected by the selectively transmitting interfaces to retain the optical beams within the sides of the regular pentagonal arrangement until the optical beams have arrived at ones of the plurality of selectively transmitting interfaces for which the corresponding wavelengths match the wavelengths of the optical beams or have arrived at the fully-transmissive side of the regular pentagonal arrangement.

29. The method of claim 16, wherein the plurality of selectively transmitting interfaces are polarization-selective interfaces.

30. The method of claim 16, wherein the plurality of selectively transmitting interfaces are wavelength-independent partially-transmissive mirrors.

31. An optical device, comprising:
a plurality of wavelength-selective interfaces for selectively transmitting light of corresponding wavelengths and reflecting light of other wavelengths; and
a device body for securing the plurality of wavelength-selective interfaces as sides of a regular pentagonal arrangement, wherein portions of one or more optical beams having wavelengths other than the wavelengths corresponding to the wavelength-selective interfaces are retained within the sides of the regular pentagonal arrangement until the portions of the one or more optical beams have arrived at one of the plurality of selectively transmitting interfaces having a corresponding wavelength matching a wavelength of the portion of the one or more optical beams or have arrived at a fully-transmissive side of the regular pentagonal arrangement.
